(19) United States
(12) Patent Application Publication
(10) Pub. No.: US 2006/0232654 A1
(43) Pub. Date: Oct. 19, 2006

(54) Image forming apparatus

(75) Inventor: Masayuki Fujimoto, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/397,691

(22) Filed: Apr. 5, 2006

(30) Foreign Application Priority Data
Apr. 14, 2005 (JP) 2005-116488

(51) Int. Cl. B41J 2/385

(52) U.S. Cl. 347/132

(57) ABSTRACT

In a laser beam printer, an optimized output power of a laser beam can be obtained without using an expensive laser driving IC. A first comparator device 35 compares an output voltage of a photodiode 32 with a first reference voltage and a second comparator device 36 compares the output voltage of the photodiode 32 with a second reference voltage. A control unit 12 adjusts a duty ratio of a PWM signal outputted to a laser driving circuit 33 based on the output signals from the first comparator device 35 and the second comparator device 36, so that the output power of the laser beam emitted from the laser chip 31 can be optimized. Thereby, the expensive laser driving IC can be omitted, thereby enabling the reduction of cost of the image forming apparatus.

### BACKGROUND OF THE INVENTION

1. Field of the Invention

The present invention relates to an image forming apparatus having a laser scan unit for forming a latent image on a surface of a photoconductor drum by irradiating a laser beam while scanning.

2. Description of the Related Art

A laser device used in a laser scan unit of an image forming apparatus is comprised of a laser chip emitting a laser beam, and a photodiode receiving a part of the laser beam for monitoring an output of the laser chip. The photodiode converts the received laser beam to an electric signal and feeds back the electric signal to a laser driving IC for driving the laser chip. When the laser driving IC receives the electric signal, it controls current flowing to the laser chip based on the electric signal. In this way, the output power of the laser chip is automatically controlled by the laser driving IC (hereinafter, it is abbreviated as automatic power control). As is commonly known, the output characteristic of the laser chip depends on a temperature of the laser device, so that it is necessary to optimize the output power of the laser chip by performing the above automatic power control while an image is formed on a paper sheet by the image forming apparatus.

However, in the conventional image forming apparatus such as a laser beam printer, the laser driving IC, which is expensive about one US dollar, is indispensable for performing the automatic power control precisely, so that it causes the increase of cost of the image forming apparatus.

By the way, Japanese Laid-Open Patent Publication No. 2003-69139 or No. 2002-2021 discloses a laser beam printer in which laser driving current can always be set as proper condition in sample holding automatic power control so that proper output power of the laser beam can be obtained even though printing speed is changed. Furthermore, Japanese Laid-Open Patent Publication No. 3-191659 discloses a laser beam printer in which output power of the laser beam can be adjusted in a predetermined scope corresponding to deterioration of a photoconductor drum.

### SUMMARY OF THE INVENTION

A purpose of the present invention is to provide an image forming apparatus and a laser scan unit used therein, in which output power of a laser beam can be adjusted in a proper condition by an inexpensive configuration with using no laser driving IC.

An image forming apparatus in accordance with an aspect of the present invention comprises a laser scan unit for forming a latent image on a surface of a photoconductive drum by irradiating a laser beam while scanning. The laser scan unit further comprises: a laser emitting device emitting a laser beam; a laser driver for driving the laser emitting device; a laser receiving device receiving a part of the laser beam emitted from the laser emitting device so as to monitor output power of the laser emitting device, converting the received laser beam to electric signal and outputting the electric signal; a comparator comparing the electric signal with at least a predetermined reference voltage and outputting a comparison signal corresponding to result of comparison; and a controller adjusting a laser control signal based on the comparison signal outputted from the comparator and outputting the adjusted laser control signal so that the output power of the laser emitting device is adjusted in a proper condition.

The electric signal outputted from the laser receiving device which corresponds to the output power of the laser emitting device is compared with the predetermined reference voltage. When the voltage of the electric signal is higher than the predetermined reference voltage, the comparison signal shows, for example, that the output power of the laser emitting device is higher than the proper condition, so that the controller adjusts the laser control signal so as to decrease the output power of the laser emitting device by a predetermined level. Alternatively, when the voltage of the electric signal is lower than the predetermined reference voltage, the comparison signal shows that the output power of the laser emitting device is lower than the proper condition, so that the controller adjusts the laser control signal so as to increase the output power of the laser emitting device by the predetermined level. By repeating such controls, the output power of the laser emitting device can be converged in the proper condition. By such a configuration, the output power of the laser emitting device can be controlled in the proper condition without using the expensive laser driving IC. In comparison with the laser driving IC, the cost of the comparator is much lower, so that it is possible to reduce the manufacturing cost of the laser scan unit and the image forming apparatus using the same.

### BRIEF DESCRIPTION OF THE DRAWINGS

FIG. 1 is a sectional view showing a configuration of a laser beam printer which is an example of an image forming apparatus in accordance with an embodiment of the present invention;

FIG. 2 is a circuit diagram showing an electric configuration of a laser scan unit used in the above laser beam printer; and

FIG. 3 is a chart showing PWM signals outputted from a control unit corresponding to an output signal of a comparator.

### DETAILED DESCRIPTION OF THE EMBODIMENT

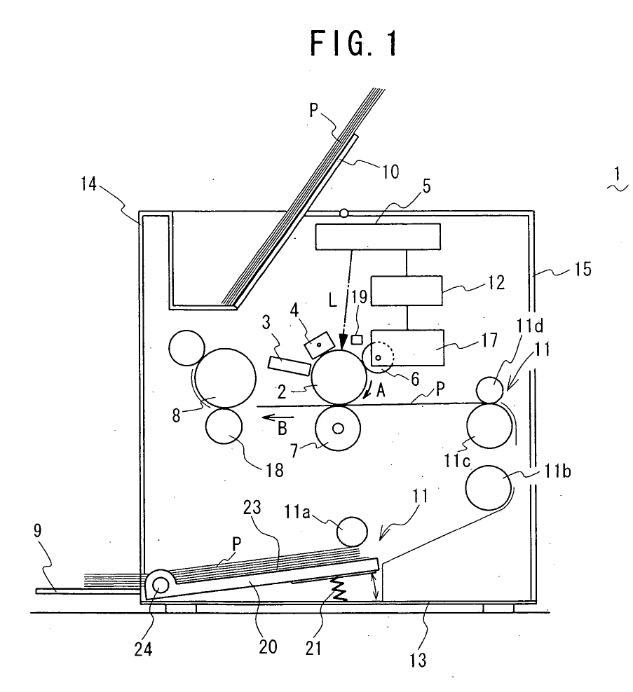

An image forming apparatus and a laser scan unit used therein in accordance with an embodiment of the present invention is described with reference to attached drawings. FIG. 1 shows a configuration of a laser beam printer 1 as an example of the image forming apparatus in accordance with this embodiment.

The laser beam printer 1 comprises a photoconductor drum 2 that a photoconductive material is applied on a surface thereof. A cleaner 3, a charger (charging means) 4, a laser scan unit (exposing means) 5, a developing brush (developing means) 6 and a transfer roller (transfer means) 7 are serially disposed around the photoconductor drum 2 from upstream side to downstream side of revolution direction shown by arrow A. A fixing roller (fixing means) 8 and a pressure roller 18 are disposed at downstream side of a paper conveying direction of a paper sheet P shown by arrow B from the transfer roller 7. A paper feed tray, to which paper sheets P are loaded, is disposed in a bottom portion of a housing 14 of the laser beam printer 1. An exit tray 10, to which printed paper sheets P are piled up, is disposed at a top portion of the housing 14. A paper conveying mechanism (conveying means) 11 is provided in the housing 14 so as to convey the paper sheep P one by one from the paper feed tray 9 to the exit tray 10 through the above mentioned transfer roller 7 and the fixing roller 8. The laser beam printer 1 further has a control unit (controller or control means) 12 for controlling each unit of the apparatus. The above-mentioned elements are fixed on a metal frame 13 disposed inside the housing 14. A cover 15 is provided on the housing 14 in openable and closable manner so that a jammed paper sheet P in the paper conveying mechanism 11 can be removed or a toner cartridge 17 can be replaced.

A temperature sensor 19 is provided in the vicinity of the photoconductive drum 2 for detect a temperature of periphery of the photoconductive drum 2. The temperature detected by the temperature sensor is fed back to the control unit 12 in occasions of exposure, development and fixing processes.

The cleaner 3 removes toner remained on a surface of the photoconductor drum 2 which adhered in a previous developing process and powder of paper so that the surface of the photoconductor drum is swept. The charger 4 uniformly charges the surface of the photoconductor drum 2 swept by the cleaner 3.

The laser scan unit 5 irradiates a laser beam with scanning on the surface of the photoconductor drum 2 which is uniformly charged by the charger 4 so as to form a latent image on the surface of the photoconductor drum 2. A predetermined voltage which is necessary for emitting the laser beam from a laser emitting device is applied to the laser scan unit 5 from a power supply (not shown).

The developing brush 6 is attached to the toner cartridge 17 into which toner particles are filled. The developing brush 6 contacts the surface of the photoconductor drum 2 to adhere the toner particles to the portion where the latent image is formed, so that the latent image is developed by forming a toner image on the surface of the photoconductor drum 2 with the toner particles.

The transfer roller 7 is provided to face the surface of the photoconductor drum 2 so as to charge a surface of a paper sheet P conveyed in a clearance between the photoconductor drum 2 and the transfer roller 7 with a pressure. The toner particles adhered on the surface of the photoconductor drum 2 are transferred to the surface of the paper sheet P by electrostatic force so that the toner image is transferred to the surface of the paper sheet P. A predetermined voltage for charging the surface of the paper sheet P is applied to the transfer roller 7 by the power supply.

The paper sheet P to which the toner image is transferred is wedged between the fixing roller 8 and the pressure roller 18 so that a pressure and a heat are applied to the paper sheet P. The toner particles adhered on the paper sheet P are melted and pressed to the paper sheet P, so that the toner particles are fixed on the paper sheet P, and thereby the toner image is fixed on the paper sheet P. A heater (not shown) is built-in the fixing roller 8 so as to generate the heat for melting the toner particles. A predetermined voltage for generating the heat is supplied from the power supply.

The paper conveying mechanism 11 is comprised of a pickup roller 11a, conveying rollers 11b, 11c and 11d, a paper pushing up plate 20 disposed in the vicinity of the paper feed tray 9 and pushing up the paper sheets P loaded thereon to the pickup roller 11a, and a coil spring 21 for pushing the paper pushing up plate 21 toward the pickup roller 11a.

A paper loading face 23 on which the paper sheets P are loaded is continuously formed by the paper feed tray 9 and the paper pushing up plate 20. The paper sheets P are loaded on the paper loading face 23 when a user inserts a plurality of paper sheets put together.

The pickup roller 11a is disposed to face the paper loading face 23 so as to pickup top paper sheet among the paper sheets P loaded on the paper loading face 23 and feeds to the paper conveying roller 11b. The paper conveying roller 11b conveys the paper sheet P fed by the pickup roller toward the paper conveying roller 11c. The paper conveying rollers 11c and 11d are disposed to face each other at a position between the paper conveying roller 11b and the transfer roller 7 for conveying the paper sheet P to a transfer position.

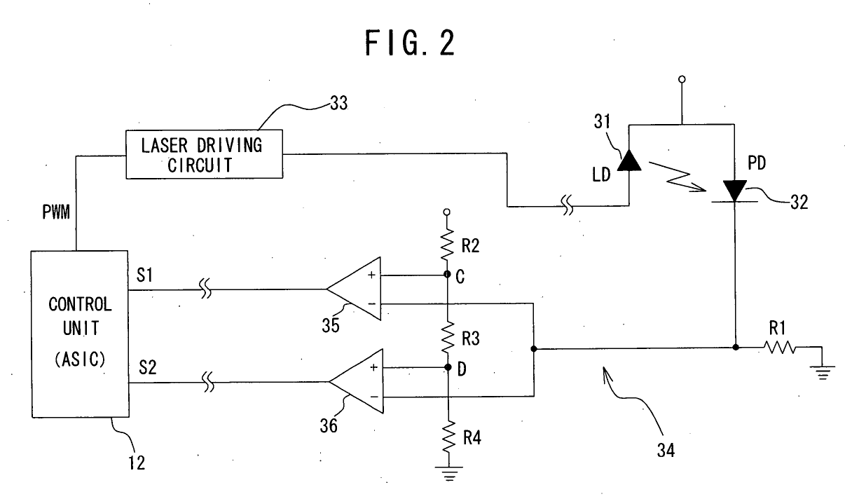

FIG. 2 shows an electric configuration of the laser scan unit 5. The laser scan unit 5 comprises a laser chip (laser emitting device) 31 for emitting the laser beam, a photodiode (laser receiving device) 32 for monitoring an output of the laser chip 31, a laser driving circuit 33 for driving the laser chip 31, and a voltage comparator circuit 34 for comparing an output voltage from the photodiode 32 with a predetermined reference value.

The photodiode 32 receives a part of the laser beam emitted from the laser chip 31, converts the received laser beam to electric signal, and outputs the electric signal to the voltage comparator circuit 34. The laser driving circuit 33 drives the laser chip 31 based on a PWM (Pulse Width Modulation) signal outputted from the control unit 12. The voltage comparator circuit 34 comprises a resistor R1 for converting output current from the photodiode 32 to a voltage, resistors R2, R3 and R4 for dividing a supply voltage Vcc into predetermined first and second reference voltages, a first comparator device 35 into which the output voltage of the photodiode 32 and the first reference voltage are inputted, and a second comparator device 36 into which the output voltage of the photodiode 32 and the second reference voltage are inputted. The first reference voltage and the second reference voltage can be set by combination of values of the resistors R2, R3 and R4 appropriately. Potential at a point C, however, becomes higher than potential at a point D by action of the resistor R3, so that the second reference voltage becomes lower than the first reference voltage. In addition, the laser chip 31 and the photodiode 32 are contained in the same package of one laser device such as a semiconductor laser. The laser driving circuit 33 and the voltage comparator circuit 34 are formed on, for example, a circuit board to which the semiconductor laser is mounted.

The output characteristics of the laser chip 31 depend on own temperature of the laser chip 31 as mentioned above. Since the temperature of the laser chip 31 is varied due to heat generated when the laser chip 31 emits the laser beam, it is necessary to control the output power of the laser beam optimally by performing the above automatic power control while printing of an image on a paper sheet P is performed.

When the output voltage of the photodiode 32 is higher than the first reference voltage, a first comparison signal S1 of the first comparator device 35 becomes low level. Alternatively, when the output voltage of the photodiode 32 is equal to or lower than the first reference voltage, the first comparison signal S1 of the first comparator device 35 becomes high level. Similarly, when the output voltage of the photodiode 32 is equal to or higher than the second reference voltage, a second comparison signal S2 of the second comparator device 36 becomes low level. Alternatively, when the output voltage of the photodiode 32 is lower than the second reference voltage, the second comparison signal S2 of the second comparator device 36 becomes high level.

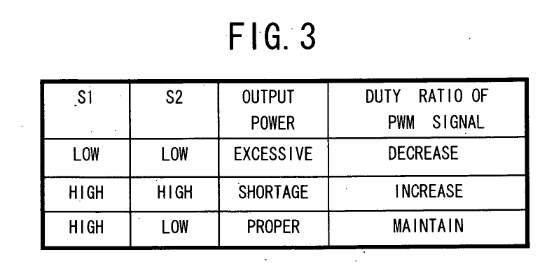

FIG. 3 shows motion of the control unit 12 when the control unit 12 adjusts the PWM signal based on the first and second comparison signals S1 and S2 of the comparator devices 35 and 36. When both of the first comparison signal S1 of the first comparator device 35 and the second comparison signal S2 of the second comparator device 36 are low level, the control unit 12 judges that output power of the laser chip 31 is excessive. Then, the control unit 12 decreases duty ratio (or on duty) of the PWM signal outputted to the laser driving circuit 33. Alternatively, when both of the first comparison signal S1 of the first comparator device 35 and the second comparison signal S2 of the second comparator device 36 are high level, the control unit 12 judges that output power of the laser chip 31 is shortage. Then, the control unit 12 increases duty ratio of the PWM signal outputted to the laser driving circuit 33. Furthermore, when the first comparison signal S1 of the first comparator device 35 is high level but the second comparison signal S2 of the second comparator device 36 is low level, the control unit 12 judges that output power of the laser chip 31 is proper. Then, the control unit 12 maintains the duty ratio of the PWM signal as it is.

According to the laser beam printer 1 of this embodiment mentioned above, the first comparator device 35 and the second comparator device 36 compares the voltage level of the electric signal outputted from the photodiode 32 with the levels of the first reference voltage and the second reference voltage, and the control unit 12 adjust the duty ratio of the PWM signal based on result of the comparison. Thus, it is possible to control the output power of the laser chip 31 optimally without using the expensive laser driving IC, thereby enabling the reduction of cost of the laser beam printer 1. The control unit 12 can be realized by only adding a new function for adjusting the duty ratio of the PWM signal to an ASIC (Application Specific Integrated Circuit) which is incorporated with the laser beam printer q to control each unit thereof, so that a manufacturing cost of the control unit 12 is not increased so much. The comparators which is indispensable instead of the laser driving IC are at a very cheap price (for example, about 0.1 to 0.2 US dollar per one component) than the laser driving IC (for example, about one US dollar per one component), so that the manufacturing cost of the image forming apparatus can be reduced dramatically even though other components such as the resistors R1, R2, R3 and R4 are considered.

The present invention is not limited to the configuration of the above mentioned embodiment, and can be modified in various manners. The laser scan unit 5 can be applied to various types of image forming apparatus of electrophotography other than the laser beam printer. Furthermore, the voltage comparator circuit 34 is not limited to the configuration shown in FIG. 2, and it may have another configuration which can output combination of output signals S1 and S2 as shown in FIG. 3.

The laser scan unit in accordance with the present invention may comprise at least a laser emitting device emitting a laser beam, a laser driver for driving the laser emitting device, a laser receiving device receiving a part of the laser beam emitted from the laser emitting device so as to monitor output power of the laser emitting device, converting the received laser beam to electric signal and outputting the electric signal, a comparator comparing the electric signal with at least a predetermined reference voltage and outputting a comparison signal corresponding to result of comparison, and a controller adjusting a laser control signal based on the comparison signal outputted from the comparator and outputting the adjusted laser control signal so that the output power of the laser emitting device is adjusted in a proper condition.

Since the electric signal outputted from the laser receiving device corresponds to the output power of the laser emitting device, it is compared with the predetermined reference voltage. A difference between the voltage of the electric signal and the predetermined reference voltage shows the difference between the actual level of the output power of the laser emitting device and the proper output level thereof. The controller can adjust the laser control signal so as to increase or decrease the output power of the laser emitting device based on the comparison signal outputted from the comparator. By repeating such controls, the output power of the laser emitting device can be converged in the proper condition. Since the cost of the comparator is much lower than that of the laser driving IC, it is possible to reduce the manufacturing cost of the laser scan unit and the image forming apparatus using the same.

It is possible to configure that the comparator compares the voltage of the electric signal with a first reference voltage and a second reference voltage lower than the first reference voltage, and outputs a first comparison signal corresponding to result of comparison of the voltage of the electric signal with the first reference voltage and a second comparison signal corresponding to result of comparison the electric signal with the second reference voltage, and the controller adjusts the laser control signal based on the first comparison signal and the second comparison signal.

For example, when the voltage of the electric signal is higher than the first reference voltage, the controller adjusts the laser control signal so as to decrease the output power of the laser emitting device. Alternatively, when the voltage of the electric signal is lower than the second reference voltage, the controller adjusts the laser control signal so as to increase the output power of the laser emitting device. And when the voltage of the electric signal is equal to or lower than the first reference voltage and equal to or higher than the second reference voltage, the controller maintains the output power of the laser emitting device as it is. By such a configuration, the controller can easily control the output power of the laser emitting device.

The laser control signal may be a PWM (Pulse Width Modulation) signal outputted from the controller and the laser driver drives the laser emitting device based on the PWM signal. When the voltage of the electric signal is higher than the first reference voltage, the controller decreases duty ratio of the PWM signal. Alternatively, when the voltage of the electric signal is lower than the second reference voltage, the controller increases the duty ratio of the PWM signal. And when the voltage of the electric signal is equal to or lower than the first reference voltage and equal to or higher than the second reference voltage, the controller maintains the duty ratio of the PWM signal as it is. Thereby, the controller for controlling the output power of the laser emitting device can be configured simple.

This application is based on Japanese patent application 2005-116488 filed Apr. 14, 2005 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An image forming apparatus comprising a laser scan unit for forming a latent image on a surface of a photoconductive drum by irradiating a laser beam with scanning, wherein
the laser scan unit further comprises:
a laser emitting device emitting a laser beam;
a laser driver for driving the laser emitting device;
a laser receiving device receiving a part of the laser beam emitted from the laser emitting device so as to monitor output power of the laser emitting device, converting the received laser beam to electric signal and outputting the electric signal;
a comparator comparing voltage of the electric signal with at least a predetermined reference voltage and outputting a comparison signal corresponding to result of comparison; and
a controller adjusting a laser control signal based on the comparison signal outputted from the comparator and outputting the adjusted laser control signal so that the output power of the laser emitting device is adjusted in a proper condition.

2. The image forming apparatus in accordance with claim 1, wherein
the comparator compares the voltage of the electric signal with a first reference voltage and a second reference voltage lower than the first reference voltage, and outputs a first comparison signal corresponding to result of comparison of the voltage of the electric signal with the first reference voltage and a second comparison signal corresponding to result of comparison the electric signal with the second reference voltage; and
the controller adjusts the laser control signal based on the first comparison signal and the second comparison signal.

3. The image forming apparatus in accordance with claim 2, wherein
when the voltage of the electric signal is higher than the first reference voltage, the controller adjusts the laser control signal so as to decrease the output power of the laser emitting device;
when the voltage of the electric signal is lower than the second reference voltage, the controller adjusts the laser control signal so as to increase the output power of the laser emitting device; and
when the voltage of the electric signal is equal to or lower than the first reference voltage and equal to or higher than the second reference voltage, the controller maintains the output power of the laser emitting device as it is.

4. The image forming apparatus in accordance with claim 3, wherein
the laser control signal is a PWM (Pulse Width Modulation) signal outputted from the controller and the laser driver drives the laser emitting device based on the PWM signal;
when the voltage of the electric signal is higher than the first reference voltage, the controller decreases duty ratio of the PWM signal;
when the voltage of the electric signal is lower than the second reference voltage, the controller increases the duty ratio of the PWM signal; and
when the voltage of the electric signal is equal to or lower than the first reference voltage and equal to or higher than the second reference voltage, the controller maintains the duty ratio of the PWM signal as it is.

5. An image forming apparatus comprising:
a photoconductor drum that a photoconductive material is applied on a surface thereof;
a charging means for charging the surface of the photoconductor drum uniformly;
an exposing means for forming a latent image on the surface of the photoconductor drum by irradiating a laser beam while scanning;
a developing means for forming a toner image by adhering toner particles to a portion on the surface of the photoconductor drum where the latent image is formed;
a transfer means provided at a transfer position downstream side from the developing means in revolving direction of the photoconductor drum so as to face the surface of the photoconductor drum, and transfer the toner image formed on the surface of the photoconductor drum to a paper sheet;
a fixing means for fixing the toner image on the paper sheet by applying heat and pressure to the paper sheet to which the toner image is transferred; and
a control means for controlling above each means and outputting on a PWM (Pulse Width Modulation) signal used for controlling output power of the laser beam; and wherein
the exposing means is comprised of: a laser emitting device emitting a laser beam; a laser receiving device receiving a part of the laser beam emitted from the laser emitting device, converting the received laser beam to electric signal and outputting the electric signal to the control means; a first comparator comparing voltage of the electric signal with a first reference voltage; a second comparator comparing the voltage of the electric signal with a second reference voltage lower than the first reference voltage; and a laser driving circuit for driving the laser emitting device based on the PWM signal outputted from the control means;
when the voltage of the electric signal is higher than the first reference voltage, the control means decreases duty ratio of the PWM signal;
when the voltage of the electric signal is lower than the second reference voltage, the control means increases duty ratio of the PWM signal; when the voltage of the electric signal is equal to or lower than the first reference voltage and equal to or higher than the second reference voltage, the controller maintains the duty ratio of the PWM signal as it is; and
thereby the output power of the laser emitting device can be controlled in a proper condition without using laser driving IC.

6. A laser scan unit comprising:
a laser emitting device emitting a laser beam;
a laser driver for driving the laser emitting device;
a laser receiving device receiving a part of the laser beam emitted from the laser emitting device so as to monitor output power of the laser emitting device, converting the received laser beam to electric signal and outputting the electric signal;
a comparator comparing the electric signal with at least a predetermined reference voltage and outputting a comparison signal corresponding to result of comparison; and
a controller adjusting a laser control signal based on the comparison signal outputted from the comparator and outputting the adjusted laser control signal so that the output power of the laser emitting device is adjusted in a proper condition.
